(19) United States
(12) Patent Application Publication
(10) Pub. No.: US 2006/0134324 A1
(43) Pub. Date: Jun. 22, 2006

(54) Filament with easily removed protective coating and methods for stripping the same

(75) Inventors: Martin A. Putnam, Cheshire, CT (US); Michel Perbost, Bethany, CT (US); Robert N. Brucato, Southington, CT (US)

Correspondence Address: Illumina, Inc.;c/o Portfolio IP, PO Box 52050, Minneapolis, MN, 55402, US

(73) Assignee: Illumina, Inc.

(21) Appl. No.: 11/283,517

(22) Filed: Nov. 17, 2005

Related U.S. Application Data
(60) Provisional application No. 60/629,006, filed on Nov. 17, 2004.

(51) Int. Cl. B05D 5/06; B05D 1/18

(52) U.S. Cl. 427/163.2; 427/434.6; 427/443

(57) ABSTRACT

The present invention provides a filament with an easily removable protective coating as well as a method and apparatus for applying the protective coating to the filament during a draw process that can be easily removed with a reasonably benign solvent such as water, or if necessary, acetone or ethanol. The protective coating is water-soluble and can be easily dissolved in-line with a spooling process. The coating material may include a water-soluble “wax-like” material called Aquabond 65, distributed by Aquabond Technologies, as well as other grades of Aquabond such Aquabond 55 and Aquabond 85, which behave essentially the same but are dissolved at different temperatures.

### CROSS REFERENCES TO RELATED APPLICATIONS

This application claims benefit to provisional patent application No. 60/629,006 (WFVA/CyVERA nos. 714-1.18/CV 75PR), filed Nov. 17, 2004, which is hereby incorporated by reference in their entirety.

The following cases contain subject matter related to that disclosed herein and are incorporated herein by reference in their entirety: U.S. patent application Ser. No. 10/661,116 (CyVera Docket No. CV-0044), filed Sep. 12, 2003, entitled “Method of Manufacturing of a Diffraction grating-based identification Element”.

### BACKGROUND OF INVENTION

1. Technical Field

The present invention relates to a method and apparatus for manufacturing a filament having an easily removed protective coating, as well as a method and apparatus for easily removing the protective coating from the filament.

2. Description of Related Art

Optical filament is typically manufacturer with a protective coating that protects the filament during its handling from the time it is manufactured to the time its is used in any particular application.

When such filament is used to make microbeads, the fabrication of micro beads requires as a starting material a very small glass filament, approximately 28 microns in diameter. Before codes can be written into the filament the protective coating must be removed. For this, there are different known techniques, including thermal-mechanical, thermal, chemical-mechanical and chemical (e.g. sulphuric acid), for removing the protective coating from the filament.

In particular, the thermal-mechanical process involved heating the coating to about 500 degrees C. while pulling it through a mechanical die, which physically strips the coating off the filament. The approach works on conventional filament sizes (125 um-65 um) with conventional coatings, such as a UV cured acrylate. However, due to the mechanical nature of the process, the filament was inevitably weakened. Moreover, this approach breaks down with filament smaller than 65 um. Since the target filament size for micro beads is 28 microns (um), this approach is not effective.

The thermal ablation method may be used to remove the protective coating from the filament that is used to make microbeads. This method involves using superheated nitrogen (˜1000 degrees C.) to essentially evaporate the coating off the filament without ever needing to touch it with a die. Although this method essentially works in that it removed the coating, it has the disadvantage of having a slow speed combined with questions surrounding the effectiveness of the strip at the molecular level.

In view of this, there is a need in the industry to remove the protective coating from the filament that overcomes the aforementioned disadvantages of the methods known in the art.

### SUMMARY OF INVENTION

The present invention provides a new and method and apparatus for applying a removable protective coating to the filament during a draw process that can be easily removed with a reasonably benign, and environmentally-friendly, solvent such as water, or if necessary, acetone or ethanol. The protective coating can be easily dissolved in-line with the spooling process.

The material may include a water-soluble “wax-like” material called Aquabond 65, distributed by Aquabond Technologies, as well as other grades of Aquabond such Aquabond 55 and Aquabond 85, which behave essentially the same but are dissolved at different temperatures.

Another material, which may be used for this application is called Crystalbond. However, this is soluble in acetone, which is more hazardous and therefore more expensive to work with.

The present invention also relates to the method and Illumina, Inc. Proprietary apparatus for easily removing the protective coating with the reasonably benign, and environmentally-friendly, solvent, as well as the microbeads resulting from using all of these new techniques.

The present invention also has the following advantages, including minimizing the volume of reagent needed, providing easy to set up devices, and providing easy to scale up and down depending on the requirements of the application.

### BRIEF DESCRIPTION OF THE DRAWING

The drawing, which are not drawn to scale, include the following:

FIG. 1 shows apparatus for applying a protective coating to a filament being drawn in a draw tower that is easily removable according to the present invention.

FIG. 2, including FIGS. 2(a) and (b), show two graphs, one having break strain (% dl/length) plotted versus cumulative failure probability, the other having mean distance between failure (meters) plotted versus mean load (grams).

FIG. 3 shows a method for removing or stripping the protective coating from a filament according to the present invention.

FIG. 3a shows one or more alternative methods for removing or stripping the protective coating from a filament according to the present invention.

FIG. 4 shows another method for removing or stripping the protective coating from a filament according to the present invention.

FIG. 5 shows four photographs of the filament based on these new techniques, including FIG. 5(a) showing a filament having full coat; FIGS. 5(b) and (c) showing a filament after stripping using the method in FIG. 4, and FIG. 5(d) showing a filament after stripping using the method in FIG. 3.

### DETAILED DESCRIPTION OF THE INVENTION

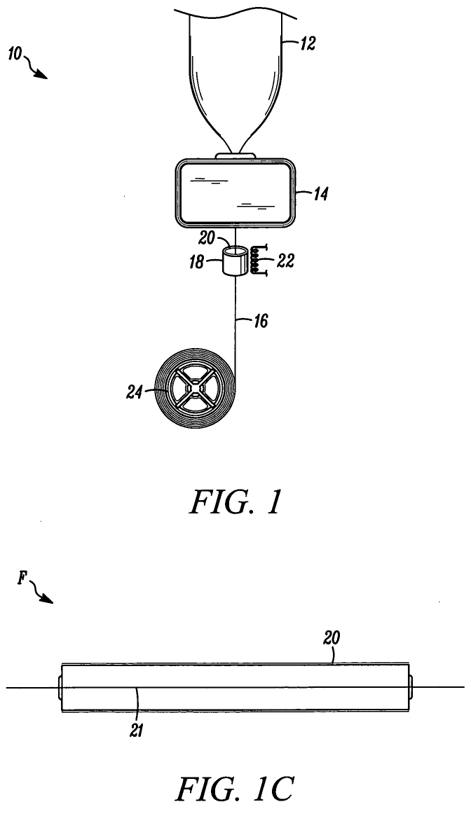

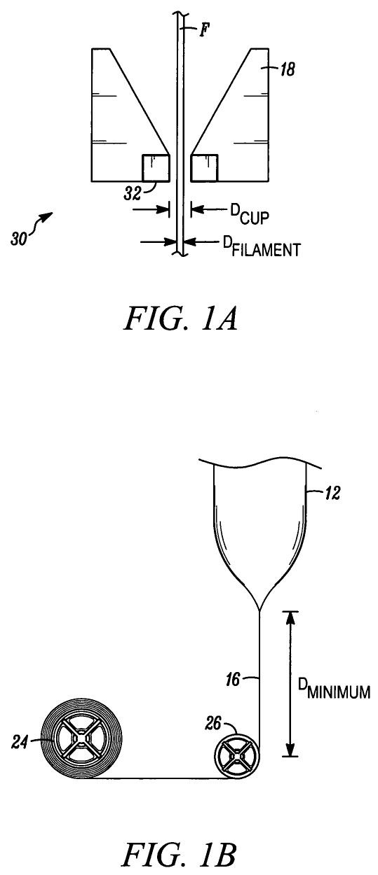

### FIG. 1: Applying the Coating

FIG. 1 shows a drawing tower generally indicated as 10 having a preform 12 arranged in a furnace 14, in which a filament 16 of bare glass is drawn. In operation, the bare filament 16 is coated by passing it through a cup 18 that has a hole in the bottom and is filled with an Aquabond coating 20. A heater 22 arranged in relation to the cup 18 provides heat to the cup 18 for maintaining it at a predetermined temperature. After the filament is coated with Aquabond 20, the filament 16 with the Aquabond coating 20 thereon is taken-up on a wheel or spool 24, as shown.

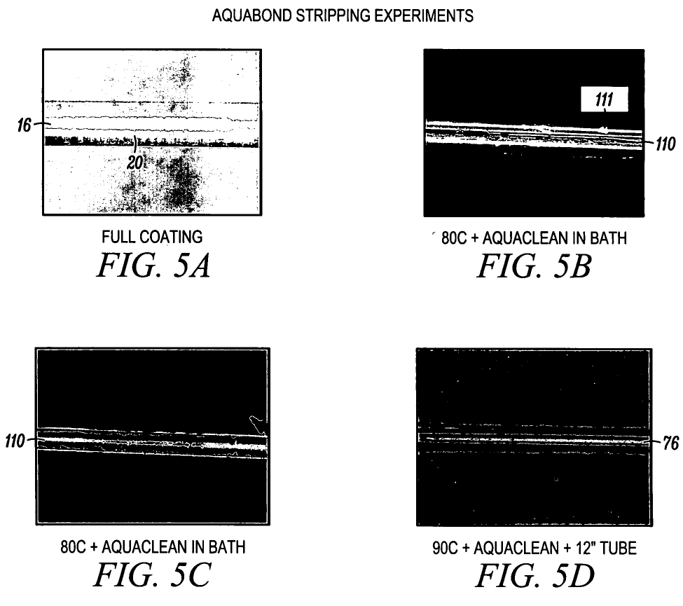

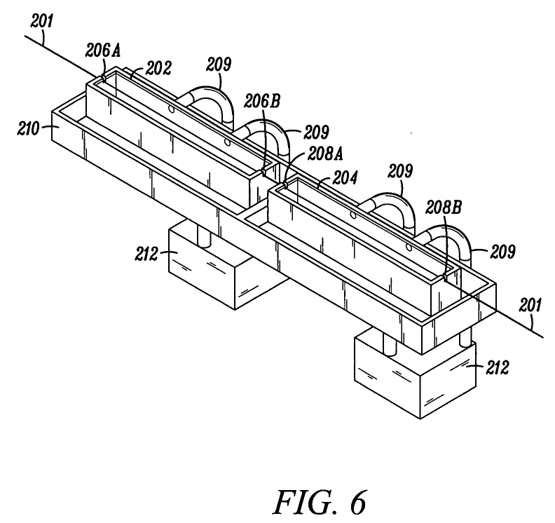

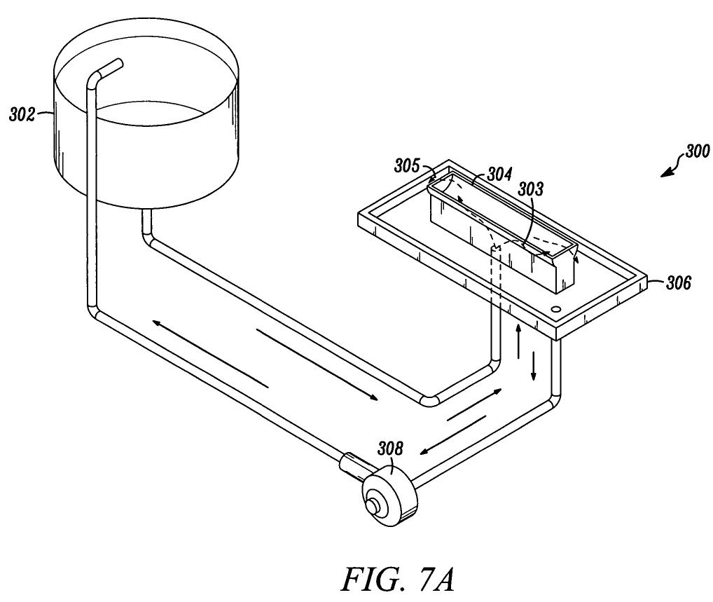

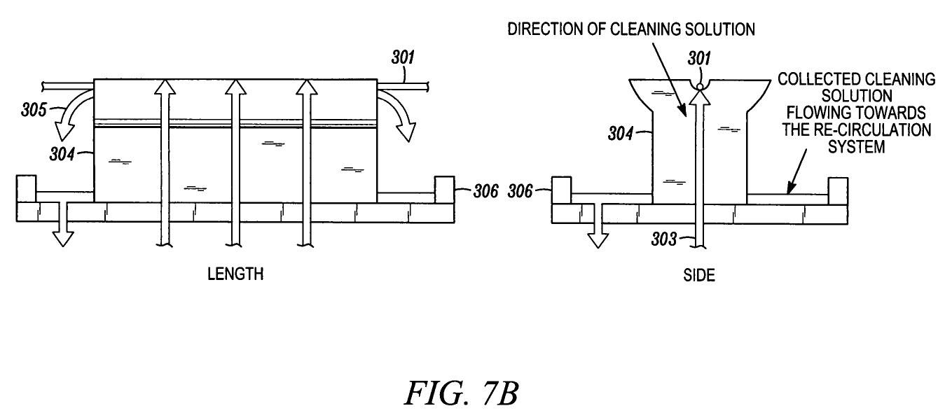

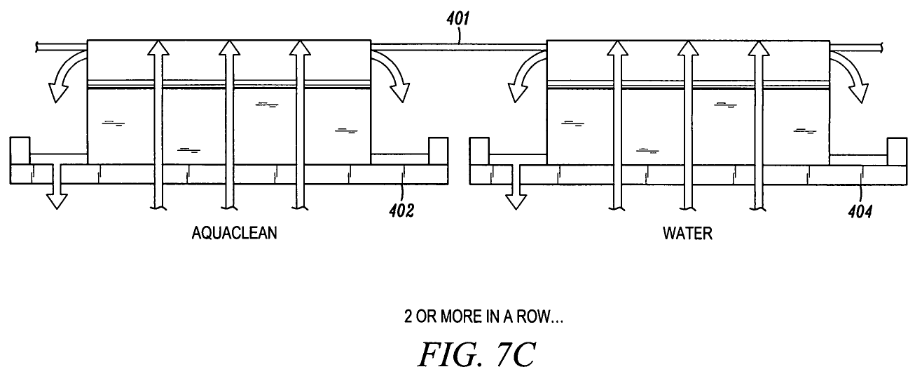

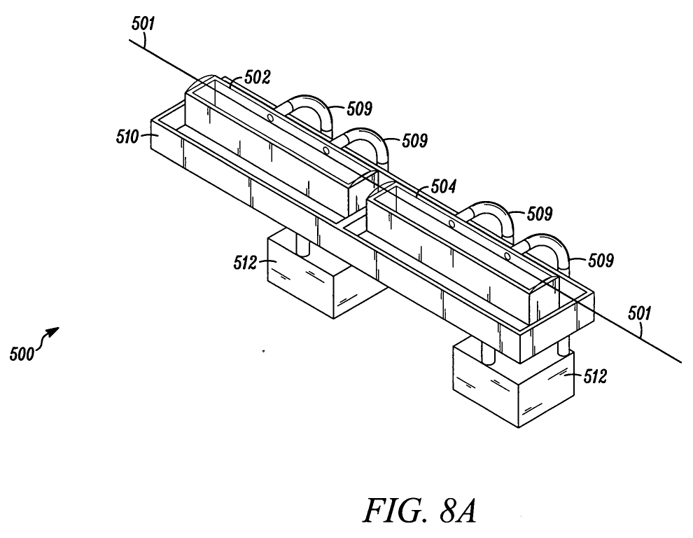

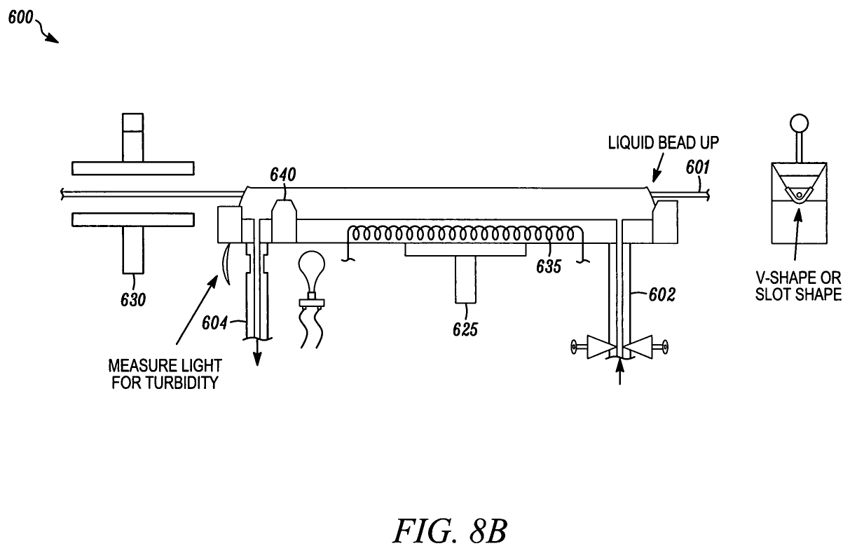

FIG. 5(a) shows a filament 16 having a full coating of Aquabond according to the present invention.

In effect, the method involves applying the Aquabond coating 20 directly to the filament 16 during the draw process. Like other thermoplastic coatings the material transitions from a solid to a liquid at an elevated temperature. Aquabond 65 begins to soften at about 60 degrees C. and becomes watery at about 80 degrees C. To apply the Aquabond coating 20 to the filament 16, the heated cup 18 with the small hole or die is used to establish the diameter of the coating material (<about 100 microns works best). The optimal viscosity was achieved when the cup 18 was heated to about 70 degrees C. It was determined that once the filament 16 is drawn and spooled on a mandrel, it can be handled normally without risk of degrading its pristine strength.

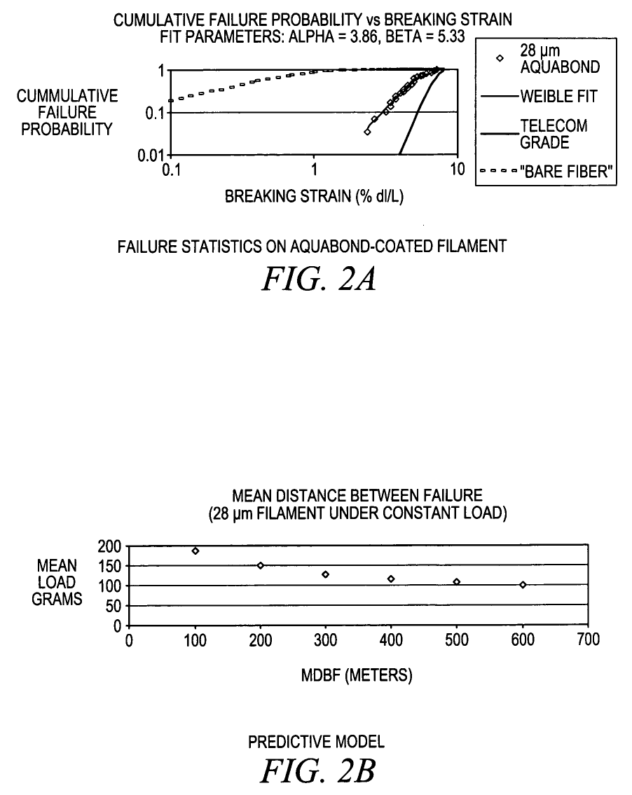

FIG. 2(a) shows a graph of the failure statistics. Bare filament tends to be extremely fragile, to the extent that it will not stay intact while it is still on the spool. Handling such filament in long contiguous lengths is virtually impossible. A characteristic Weible plot will exhibit a long slow decay rolling off less than 1% strain. Conversely, high strength telecom style filament with an optimized robust coating will exhibit a very sharp roll off starting near 7%. Such a curve indicates that the probability of failure even at high tensile strains (greater than about 6%) is very low. The failure statistics for the Aquabond coated filament, not surprisingly, indicate that the coating is not as good at maintaining strength as filament with those coatings which are designed to not be easily removed. However, the relatively steep curve indicates that the coating is providing a significant level of protection against failure use to mechanical abrasion and attack from humidity.

FIG. 1a shows, by way of example, a die/cup arrangement generally indicated as 30 having a die 32 arranged in a cup 34 for use according to the present invention. The cup 34 holds the coating material which is applied to the filament F as it passes through the arrangement. It has been determined by experimentation that the die size (D_{die}) to filament (D_{filament}) size is about 2:1 for the optimal application of the coating. This unique ratio results in self-centering forces causing the filament to pass through the center of the die 32 to increase the uniformity of the coating being applied to the filament F. In one embodiment, the die 32 is made from a silicon mold with a diameter (D_{die}) in a range of about 60-80 microns, and preferably about 75 microns, depending on the diameter (D_{filament}) of the filament.

FIG. 1b shows an alternative embodiment to that shown in FIG. 1. Similar elements are shown and described with similar reference numerals. The overall objective is to cool the coated filament in a reasonably short distance possible to keep the height/length of the overall draw tower to a minimum. In FIG. 1b, a variable speed capstan 26 is preferably arranged at a minimum distance Dₘᵢₙᵢₘᵤₘ from the preform 12 so as to provide cooling and curing of the coating on the filament. The cooling time depends on the coating thickness and the temperature difference between the surrounding environment and the filament, and the cooling distance depends on the draw velocity of the filament and the cooling time. Alternatively, a cooling tube may be added to accelerate the cooling of the coating material on the filament. The capstan 26 may be independently controlled by a capstan controller (not shown).

Embodiments are also envisioned in which multiple die/cup arrangements like element 30 used in an in-line technique for applying the protective coating to the filament 16. This embodiment may include a series of arrangements 30 such as that shown in FIG. 1a. This approach randomizes the coating centering for a more even application of the coating.

FIG. 1c shows a fiber F having the removable coating 20 and a substrate 21 in the form of a device.

### Removal of the Coating

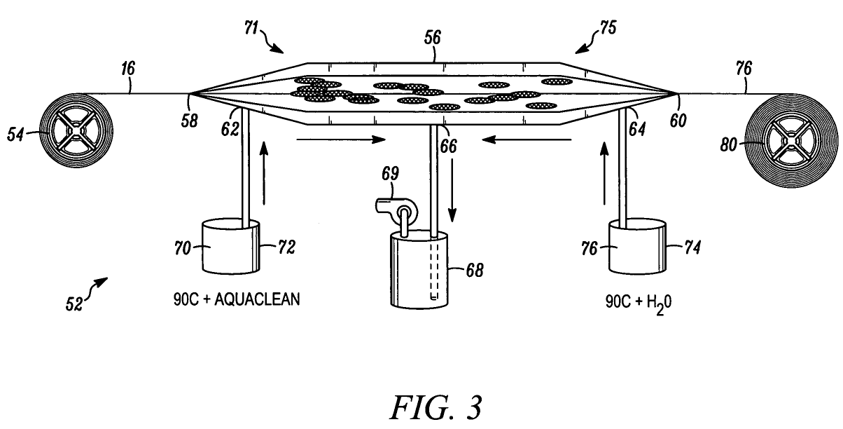

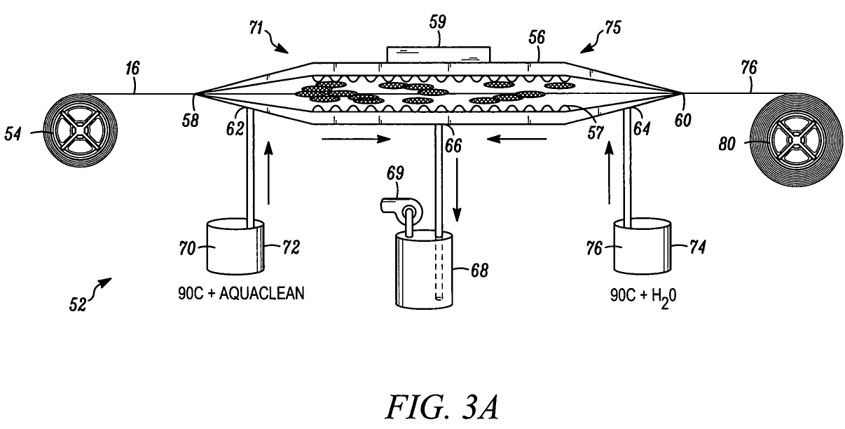

FIG. 3 shows a method and apparatus generally indicated as 52 according to the present invention for easy removal of a protective coating 20 from a filament 16, which is achieved by drawing the filament 16 off a spool 54 and through a 24 inch long Teflon tube 56 with hot water flowing through it, which is known herein as the hot aqueous stripping method. Although the present invention is described using a 24 inch long Teflon tube 56, the scope of the invention is intended to include using other length tubes and tubes made from other materials. As shown, at either end of the tube 56 there are small diameter orifices 58, 60 (e.g. about 0.020″). Although the scope of the invention is not intended to be limited to any particular orifice diameter, it has been found through experimentation that the tighter the overall fit is between the small diameter orifices 58, 60 and the filament 16, the better the overall method operates. A short distance from each end, two respective end ports 62, 64 are tied into the tube 56 to allow the flow of respective liquids into the tube 56, and a center port 66 located in the middle of the tube 56 is arranged so that liquid can be removed from the tube 56. Liquid is drawn in through the two end ports 58, 60 by applying a vacuum to the center port 66 using a vacuum pump 68 and collected in a tank 69. This prevents liquid from flowing out the small orifices 58, 60 at the ends. This three-port configuration also enables the flow of two different liquids at the same time, but separated by a virtual boundary in the middle of the tube 56.

The process uses a hot aqueous solution of detergent 70 in a temperature range of about 65-100 degrees Celsius (preferably about 90 degrees C.) in one section generally indicated as 71 provided from a container 72 and pure hot water 74 also in a temperature range of about 65-100 degrees Celsius (preferably about 90 degrees C.) in another second section 75 provided from a container 76. The aqueous solution detergent 70 is designed to dissolve the water-soluble coating, while the pure water is used to rinse or flush any residue in or from the detergent 70 and to remove undesirable entrained air. It has been found that linear draw rates exceeding 20 meters/minute have been achieved with the 24″ long tube 56 and modest water usage (less than 2 gallons/hour), although the scope of the invention is not intended to be limited to any particular draw rate. In principle, the system is scalable to nearly any linear feed rate, providing the length of the tube 56 is design to provide adequate dwell time in the hot aqueous solution 70. In addition to being highly effective at cleaning the filament 16, easy to use, environmentally friendly, and providing high throughput, this method produces very low residual tension on the filament 16, which is particularly important when ultra fine diameter filament is used (less than 40 microns). As shown, after exiting the tube 56, the stripped or bare filament 76 is wound on a take-up spool 80.

FIG. 5(d) shows the bare or stripped filament using Aquaclean according to the method shown in FIG. 3.

In alternative embodiments, water may also be drawn from a tap or line having an in-line heater with the Aquabond metered into one line and provided to port 62 and the hot water alone provided to tap 64. Moreover, instead of using the tank 69, the liquid may be drawn from port 66 into a line and drawn from the tube 56.

Embodiments are also envisioned in which the tube 56 is heated to keep the liquid at a desired temperature consistent with that described herein.

Embodiments are also envisioned in which multiple tubes like element 56 are used in an in-line technique for removing the protective coating from the filament. This embodiment may include a series of arrangements such as that shown in FIGS. 3 and/or 3a, or a series of arrangement that may include a tube such as 56 having Aquabond cleaning, followed by a tube such as 56 having a hot water cleaning, etc. The scope of the invention is not intended to be limited to any particular type or kind of in-line arrangement that may be configured consistent with that shown and described herein.

Embodiments are envisioned using a camera suitably arranged for inspecting the bare filament 76. Such a camera may be viewed by an operator or inspector for evaluating quality control, or a camera signal from the camera may be fed to a suitable processing device for analyzing the image in the camera signal and adjusting the operation of the overall device based on the same, including but not limited to adjusting the draw rate of the filament being fed through the tube 56, as well as the flow of the liquid to/from the tank 56.

Embodiments are also envisioned in which the protective of the filament is removed by steam cleaning, as well as other suitable techniques like chemical cleaning or gas cleaning, consistent with that described herein.

Moreover, the scope of the invention is not intended to be limited to using a vacuum pump for drawing the liquid out of the tube 56. For example, embodiments are envisioned using other type or kind of pumps for drawing the liquid out of the tube 56 either now known or later developed in the future, including but not limited to a diaphragm pump.

FIG. 3a shows an alternative embodiment of the present invention in which the tube 56 also has a rumble strip 57 arranged in, or forming part of the interior surface of the tube 56. By way of example, the rumble strip 57 may consist of a corrugated surface that helps to break up the laminar flow of the liquid in the tube 56. As shown, the rumble strip 57 is arranged or forms part of the upper and lower interior surface; however, embodiments are envisioned in which the rumble strip 57 is circumferentially arranged about the interior surface as well. FIG. 3a also shows an ultrasonic device 59 arranged in relation to the tube 56 which may be used to improve stripping efficiency and to keep the length of the tube 56 to a minimum.

An embodiment of the present invention is also envisioned in which the tube 56 has a transparent top surface in order for an operator to look inside for contaminants.

### The Graphs in FIGS. 2(a) and (b)

FIG. 2(b) illustrates the significance of maintaining a low working load. For the filament characterized by the failure statistics in FIG. 2(a), a predictive model was made to estimate the mean distance between failure for a range of working tensile loads. The graph in FIG. 2(b) shows that as the load (y-axis) decreases, the mean distance between failures increases. For example, the maximum usable operating load must be maintained less than 100 grams to achieve a mean distance of failure of greater than 600 meters.

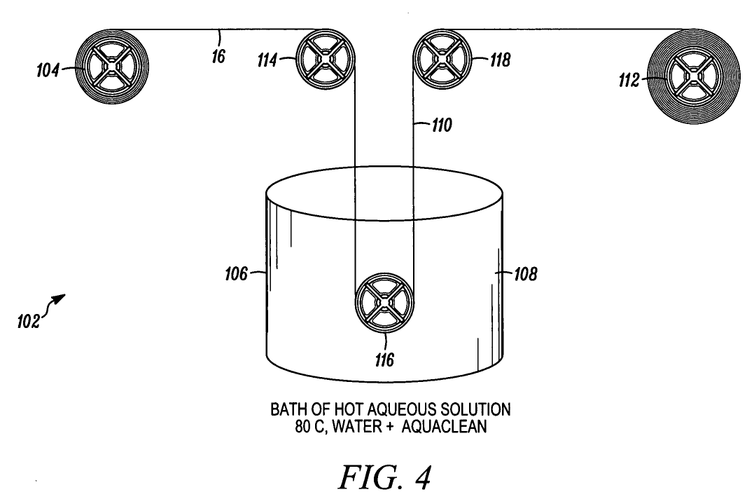

### FIG. 4: Alternative Method—the Bath Method

FIG. 4 shows a bath method generally indicated as 102 that was also developed as an alternative to the method shown in FIG. 3. The bath method involves drawing a filament such as 16 coated with Aquabond 20 from a supply spool 104 through a bath 106 having a hot aqueous detergent 108. The hot aqueous detergent 108 strips the Aquabond 20 off the filament, resulting in a stripped filament 110 that is wound on a takeup spool 112. As shown, the coated filament 16 is first drawn over a spool/wheel 114 before entering the bath 108, drawn around a spool/wheel 116 in the bath 118 and over a spool/wheel 118, then onto the takeup spool 112.

FIGS. 5(b) and 5(c) show a typical photograph of the filament 110 stripped with Aquaclean using this method. The visible residue 111 on the surface of the filament 102 was characteristic of this approach and led the inventors to develop the aforementioned improved method shown and described in relation to FIG. 2.

### FIG. 6: Trough Stripper

FIG. 6 shows another embodiment generally indicated as 200 according to the present invention, wherein the filament 201 goes through 1, 2, 3 or more small tanks 202, 204 through a groove 206a, 206b, 208a, 208b on both end. A liquid in the form of a cleaning solution is pumped via tubes 209 inside the tanks 202, 204 and overflows into a secondary container 210 below. The overflow can be either on both end where the grooves 206a, 206b, 208a, 208b are, or all around as shown. In the secondary container 210 the liquid is drained by tubes 211 to a pump 212 where it is warmed/filtered and recirculated back to the upper container 202, 204.

Alternatively, the scope of the invention is intended to include a system having one of each arrangement to accommodate various properties of liquid, for instance if the liquid cannot bead up then the groove become necessary.

This concept is designed to limit the amount of liquid used, and maximized the usage of liquid by using a re-circulation system. It minimizes the chemical waste and loss of heat.

The quality of liquid can be monitored in the recirculation loop and a supply of fresh cleaning solution could be added replacing and pushing to waste partially “dirty” cleaning solution.

### FIGS. 7a, 7b, 7c: The Overflow Stripper

FIGS. 7a, 7b, 7c show an embodiment of the invention generally indicated as 300, wherein the cleaning solution is prepared in a tank 302, then by a gravity feed, or with a pump (not shown), the liquid is pushed (see arrows 303) into the cleaning container 304 for cleaning the filament 301. The level of liquid increase until it fills completely the small tank and starts to overflow (see arrows 305). Below the small tank is a secondary container 306 collecting the overflowed liquid. At one end a tube connected to a pump 308 brings the liquids back to the container 302 (or the pump).

FIG. 7c shows an embodiment generally indicated as 400 in which one container 402 has Aquaclean for cleaning the filament 301 and the other container 404 has water, consistent with that described herein.

### FIG. 8: Surface Tension Stripper

FIGS. 8a, 8b show an embodiment of the present invention generally indicated as 500, using the concept of a meniscus stripper. Similar elements in FIGS. 6 and 8a have similar reference numerals with the additional of 300 to the reference numerals in FIG. 8a. In FIG. 8a, the filament 501 goes through 1, 2, 3 or more small tanks 502, 504. The cleaning solution is pumped via tubes 509 inside the tanks 502, 504 and overflows into a secondary container 510 below. However, in this embodiment, the filament 201 does not go through grooves as described in relation to FIG. 6, but instead surface tension of the liquid and the resulting beading up is conveniently use to allow the liquid to rise above the edge of the upper channel, and create a volume of liquid where the filament 201 can get cleaned. In the secondary container 510 the liquid is drained by tubes 211 to a pump 512 where it is warmed/filtered and recirculated back to the upper container 502, 504.

FIG. 8b shows an alternative embodiment generally indicated as 600, where there is having an inlet 602 of liquid and an overflow on the other side. At the outlet, after the overflow the liquid is monitored for change of turbidity, or any optical change of the liquid. If the liquid properties change due to contamination or increase concentration by the material it is suppose to clean, then a system controlling the flow rate of liquid in the inlet, increase the flow rate to bring the cleaning liquid to what it should be. The filament 601 to be cleaned move from the left to the right and the liquid in the opposite direction, so the dirtiest liquid face the incoming filament 601 and the clean filament has the cleanest solution. The system can have sonic device 625 to help the cleaning, an infrared lamp 630 prior to it to fragilised/liquefied the coating of the filament, and a heater 635 to maintain the overall apparatus at a desired temperature. The edge of the liquid channel may be coated with Teflon 640 to allow the liquid to bead up and increase the usable volume of liquid. The apparatus can be closed by a lid (not shown) to minimize evaporation and change of concentration, dirt and dust contamination, potential exposure to the hot liquid by an operator, and to minimize overall heat loss.

An Infrared devise 650 can be added if it is required to increase the speed of the cleaning and if the overflow system cannot keep up in removing the filament coating. It is also possible to use much higher temperature acceptable by the cleaning solution.

The sonic device 625 can be added to maximize the cleaning efficiency

### Applications

Microbeads made using the aforementioned techniques may be used in many different applications, including those set forth in the following cases, which are incorporated herein by reference in their entirety: U.S. patent application Ser. No. 10/661,234 (CyVera Docket No. CV-0038A), filed Sep. 12, 2003, entitled “Diffraction Grating-Based Optical Identification Element”; U.S. patent application Ser. No. 10/661,031 (CyVera Docket No. CV-0039A) filed Sep. 12, 2003, entitled “Diffraction Grating-Based Encoded Micro-particles for Multiplexed Experiments”; U.S. patent application Ser. No. 10/661,082 (CyVera Docket No. CV-0040), filed Sep. 12, 2003, entitled “Method and Apparatus for Labeling Using Diffraction Grating-Based Encoded Optical Identification Elements”; U.S. patent application Ser. No. 10/661,115 (CyVera Docket No. CV-0041), filed Sep. 12, 2003, entitled “Assay Stick”; U.S. patent application Ser. No. 10/661,836 (CyVera Docket No. CV-0042), filed Sep. 12, 2003, entitled “Method and Apparatus for Aligning Microbeads in order to Interrogate the Same”; U.S. patent application Ser. No. 10/661,254 (CyVera Docket No. CV-0043), filed Sep. 12, 2003, entitled “Chemical Synthesis Using Diffraction Grating-based Encoded Optical Elements”; U.S. patent application Ser. No. 10/661,116 (CyVera Docket No. CV-0044), filed Sep. 12, 2003, entitled “Method of Manufacturing of a Diffraction grating-based identification Element”; and U.S. patent application Ser. No. 10/763,995 (CyVera Docket No. CV-0054), filed Jan. 22, 2004, entitled, “Hybrid Random Bead/Chip Based Microarray”, US Provisional Patent Applications, Ser. Nos. 60/609,583, 60/610,059 and 60/609,712, all filed Sep. 13, 2004 (CV-0082PR, 83PR and 84PR); U.S. Provisional Patent Application Ser. Nos. 60/611,205, 60/610,910, 60/610,833, 60/610,829, 60/610,928, all filed Sep. 17, 2004 (CV-0085PR, 86PR, 87PR, 88PR and 89PR); U.S. Provisional Patent Application Ser. No. 60/611,676, filed Sep. 20, 2004 (CV-0091PR); and U.S. patent application Ser. No. 10/956,791, filed Oct. 1, 2004 (CV-0092 US).

### SCOPE OF THE INVENTION

The dimensions and/or geometries for any of the embodiments described herein are merely for illustrative purposes and, as such, any other dimensions and/or geometries may be used if desired, depending on the application, size, performance, manufacturing requirements, or other factors, in view of the teachings herein.

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

Moreover, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

I claim:

1. A method for applying a protective coating to a filament during a draw process, wherein the protective coating is made of a material that is easily removed with a benign solvent such as water, or if necessary, acetone or ethanol.

2. A method according to claim 1, wherein the material is a water-soluble “wax-like” material.

3. A method according to claim 2, wherein the material is Aquabond 65, as well as other grades of Aquabond such Aquabond 55 and Aquabond 85, which behave essentially the same but are dissolved at different temperatures.

4. A method according to claim 2, wherein the material is Crystalbond or a similar bonding material soluble in acetone.

5. A method according to claim 1, wherein the material is heated to about 70 degrees Celsius to achieve optimal viscosity.

6. A method for removing a protective coating applied to a filament made according to the steps of claim 1, wherein the method comprises a step of drawing the filament through a solvent for dissolving the protective coating from the filament.

7. A method according to claim 6, wherein the solvent contains a detergent.

8. A method according to claim 6, wherein the solvent contains Aquaclean.

9. A method according to claim 6, wherein the solvent is heated to a temperature in a range of 65-100 degrees Celsius, including about 90 degrees Celsius.

10. A method according to claim 6, wherein the filament is drawn through a device containing a hot aqueous solution of detergent and pure hot water.

11. A method according to claim 6, wherein the device is shaped like a tube having the hot aqueous solution of detergent substantially flowing in one section, a pure hot water substantially flowing in another second section, and a combination thereof substantially flowing in an intermediate section.

12. A method according to claim 6, wherein the device is a bath containing the hot aqueous solution and the water.

13. A method according to claim 11, wherein the method includes a coupling a vacuum pump to the device for drawing the solution from the intermediate section.

14. Apparatus for removing a protective coating applied to a filament made of a material that is easily removed with a benign solvent such as water, or if necessary, acetone or ethanol, comprising
a device containing a hot aqueous solution of the benign solvent and pure hot water for dissolving the protective coating from the filament being drawn through the device.

15. Apparatus according to claim 14, wherein the solvent contains a detergent.

16. Apparatus according to claim 14, wherein the solvent contains Aquaclean.

17. Apparatus according to claim 14, wherein the solvent is heated to a temperature in a range of 65-100 degrees Celsius, including about 90 degrees Celsius.

18. Apparatus according to claim 14, wherein the device is shaped like a tube and has a hot aqueous solution of detergent substantially flowing in one section, a pure hot water substantially flowing in another second section, and a combination thereof substantially flowing in an intermediate section.

19. Apparatus according to claim 14, wherein the device is a bath containing a hot aqueous solution and water.

20. Apparatus according to claim 14, wherein the apparatus includes a coupling a vacuum pump to the device for drawing the solution from the intermediate section.

21. Apparatus according to claim 14, wherein the device has a rumble strip.

22. Apparatus according to claim 14, wherein the apparatus has a sonic device for providing sonic waves to loosen dirt or debris from the filament.

23. Apparatus according to claim 14, wherein the apparatus has a heating device for heating the solvent.

24. Apparatus according to claim 14, wherein the apparatus has an optical device for measuring the turbidity of the solvent.

25. Apparatus according to claim 14, wherein the apparatus has an optical device for measuring the turbidity of the solvent.

25. Apparatus according to claim 14, wherein the apparatus has a camera or other suitable device for viewing the condition of the filament stripped of solvent.

26. Apparatus according to claim 14, wherein the device has V-shaped grooves for guiding the filament over the surface of the solvent using a meniscus-based technique.

27. Apparatus according to claim 14, wherein the apparatus has a container for catching solvent overflowing from the device.

28. Apparatus according to claim 14, wherein the solvent is recirculated, including removing the solvent from the device using a pump storing the solvent in a tank, and providing the solvent back to the device.

29. A coated filament, comprising:
an elongated filament substrate; and
the substrate having a filament coating surrounding the substrate, said coating being made of a water-soluble material.

30. The filament of claim 29 wherein said water soluble material is capable of being removed from said substrate by the application of water at a predetermined temperature.

31. The filament of claim 29 wherein said substrate is made of a material comprising one or more of: glass, silica, plastic, polymer, and rubber.

32. The filament of claim 29, wherein the coating comprises one or more of: Aquabond 65, Aquabond 55, and Aquabond 85.

33. An optical identification element according to claim 29, wherein the coating comprises Crystalbond or a similar bonding material soluble in acetone.
